(19) United States
(12) Patent Application Publication
(10) Pub. No.: US 2005/0227746 A1
(43) Pub. Date: Oct. 13, 2005

(54) Wireless earpiece and actuator

(76) Inventor: Mark D. Morrison, New York, NY (US)

Correspondence Address: Todd A. Sullivan;Hayes Soloway PC, 175 Canal Street, Manchester, NH, 03101, US

(21) Appl. No.: 11/132,995

(22) Filed: May 19, 2005

Related U.S. Application Data
(63) Continuation-in-part of application No. 09/707,814, filed on Nov. 7, 2000.

(51) Int. Cl. H04M 1/00

(52) U.S. Cl. 455/575.2

(57) ABSTRACT

The actuator assembly includes a base and at least one terminal integral with the base. The terminal allows the actuator assembly to connect to an audio device. An earpiece is in communication with the base. The earpiece receives audio signals from the base through wireless communication. A port is formed within the base. The port is capable of independent physical connection with the earpiece. The independent physical connection requires only parts integral with the port and/or the earpiece to make the connection.

### CROSS-REFERENCES

The present application is a continuation-in-part, claiming priority from co-pending patent application Ser. No. 09/707,814, filed on Nov. 7, 2000, and titled “Cable Retractor for an Electronic Device”.

### FIELD OF THE INVENTION

The present invention relates to an actuation device and, more specifically, for an actuation device for use with a programmable device for delivering audio information.

### BACKGROUND OF THE INVENTION

FIG. 1 shows a front view of a wireless phone 40 with a speaker 42 and a microphone 44 in the prior art. Typically, the user holds the wireless phone 40 in one hand, listens through the speaker 42, and talks into the microphone 44. The wireless phone 40 can also be used in conjunction with a combined speaker/microphone earpiece 46, as shown in FIG. 2, coupled at a distal end of a cable 48. FIG. 2 is a bottom view of the wireless phone of FIG. 1 and a combined speaker/microphone earpiece 46 in the prior art. The combined speaker/microphone earpiece 46 can be inserted in a user's ear. The combined speaker/microphone earpiece 46 picks up the sound of the user's voice from the vibrations of their jawbone. A combined speaker/microphone earpiece 46 is available from M-squared Inc. under the name EARHUGGER®. The proximal end of the cable 48 may include a jack 50 for insertion into a receptacle 52 in the base of the wireless phone 40, as shown in FIG. 2. Alternatively, the jack 50 can be coupled to the wireless phone 40 using a connector 54. A proximal end of the cable 48 may include a connector 54 for coupling to the wireless phone 40, for example, at connector terminal 55.

Portable programmable devices such as AM/FM radios, cassette player, CD players, and MP3 players are commonly used with headphones to allow the user to listen to the radio or prerecorded music without disturbing surrounding people. Similarly, people may utilize these programmable devices with an earpiece to listen to the devices. These earpieces come in many different sizes and configurations and are available at different price points and quality levels. Many users attach the portable programmable devices about their waistline and listen through the earpiece. The earpiece may be coupled to the portable electronic devices with a predetermined length of cable.

A problem with these earpieces is that no one predetermined length of cable is right for each user and activity. In order to ensure there is enough cable length for every person and activity, the manufacturers typically provide an overly long cable. If a user finds that the length of cable is too long for his or her activity, the user must somehow reduce the amount of slack. The user can eliminate the slack by wrapping a portion of the cable around the electronic device until the appropriate length of cable remains or the user can coil the cable leaving an appropriate length of cable and secure the coil with tape or string. Both of these known methods do not allow the user the freedom to easily adjust the length of dispensed cable. The winding of the cable around the electronic device or into a coil can stress the wires inside the cable that may eventually lead to failure.

When the earpiece is not in use, the user must find a convenient location to store the earpiece and the associated length of cable. Often the user stores the earpiece in his or her pocket. If the earpiece is used in conjunction with a wireless phone and the user receives an incoming call, the user must quickly locate the earpiece and connect it to the wireless phone in order to answer the call.

U.S. Pat. No. 4,989,805 entitled “Retractable Reel Assembly for Telephone Extension Cable” discloses a housing, which is adapted to be mounted to a wall in proximity to a telephone or telephone jack for utilization with either wall, mounted or table mounted telephones respectively. This device has a ratchet for selectively restraining rotation of the reel in one direction. The user can reel out an appropriate length of cable and then slowly release the cable to enable the locking mechanism. To recoil the cable, the user tugs on the cable and releases. The spring inside the housing then pulls the cable into the housing. A problem with this type of locking mechanism is that the mechanism is often difficult to engage. Another problem with a system like this is if the user accidentally tugs on the cable and releases, the cable will be uncontrollably recoiled into the housing. A further problem with systems like this is that the amount of dispensed cable is not infinitely selectable because the ratchet mechanism only has a fixed quantity of selectable positions.

Another cable retractor presently on the market includes an enclosure with a clip for attaching to a user's belt. An earpiece with a speaker is located at the end of a retractable cable. On the cable several inches from the speaker is a microphone. The retractor can be electrically connected to a cell phone with a separate, non-retractable cable. A drawback to this retractor is the cable retractor is a separate physical enclosure that cannot be mechanically coupled to the cell phone and the retractor takes up additional space on a user's belt or about their waistline. The non-retractable cable between the cell phone and the retractor can also get in the user's way.

Thus, a heretofore unaddressed need exists in the industry to address the aforementioned deficiencies and inadequacies.

### SUMMARY OF THE INVENTION

Embodiments of the present invention provide a system and method for providing an actuator assembly for use with an audio device.

Briefly described, in architecture, one embodiment of the system, among others, can be implemented as follows. The actuator includes a base and at least one terminal integral with the base whereby the terminal connects to the audio device. An earpiece is in communication with the base, whereby the earpiece receives audio signals from the base. A port is formed within the base and is capable of independent physical connection with the earpiece.

The present invention can also be viewed as providing methods for actuating an audio device. In this regard, one embodiment of such a method, among others, can be broadly summarized by the following steps: removing an earpiece from a base, wherein the base is in communication with the audio device; actuating the audio device by removing the earpiece from the base; and receiving an audio signal in the earpiece, from the audio device, through the base.

Other systems, methods, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a front view of a wireless phone in the prior art.

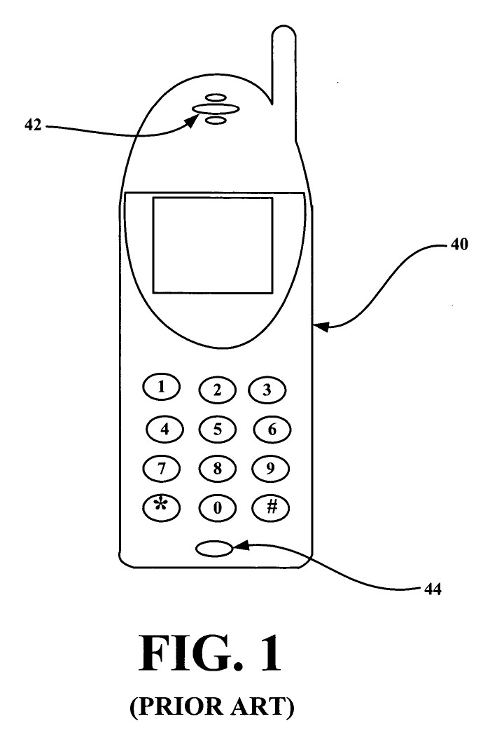

FIG. 2 is a bottom view of the wireless phone of FIG. 1 and a combined speaker/microphone earpiece in the prior art.

FIG. 3 is a front view of an actuator assembly, in accordance with a first exemplary embodiment of the invention.

FIG. 4 is a front view of the actuator assembly of FIG. 3 coupled to an audio device, a wireless phone, in accordance with the first exemplary embodiment of the invention.

FIG. 5 is a front view of an actuator assembly, in accordance with a second exemplary embodiment of the invention.

FIG. 6 is a side view of the actuator assembly of FIG. 5, in accordance with the second exemplary embodiment of the invention.

FIG. 7 is a cross-sectional view of a portion of the actuator assembly of FIG. 5, in accordance with the second exemplary embodiment of the invention.

FIG. 8 is a front view of an actuator assembly, in accordance with a third exemplary embodiment of the invention.

FIG. 9 is a cross-sectional view of a portion of the actuator assembly of FIG. 8, in accordance with the third exemplary embodiment of the invention.

FIG. 10 is a flow chart that shows the functionality and operation of a possible implementation of the actuator assembly to listen to an audio device, in accordance with the first exemplary embodiment of the invention

### DETAILED DESCRIPTION

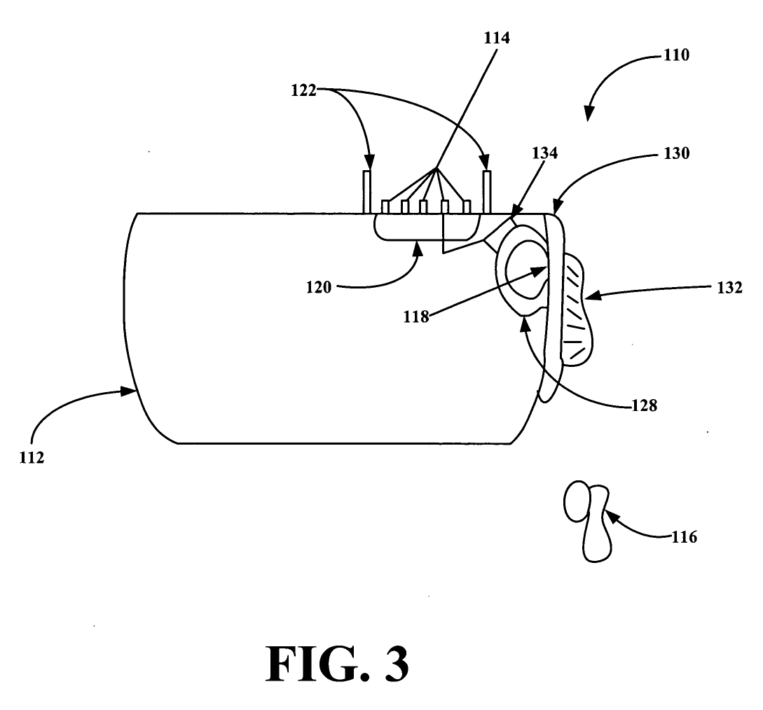

FIG. 3 is a front view of an actuator assembly 110, in accordance with a first exemplary embodiment of the invention. The actuator assembly 110 includes a base 112 and at least one terminal 114 integral with the base 112 whereby the terminal 114 connects to an audio device (not shown in FIG. 3). An earpiece 116 is in communication with the base 112, whereby the earpiece 116 receives audio signals from the base 112. A port 118 is formed within the base 112 and is capable of independent physical connection with the earpiece 116. Independent physical connection herein defined as requiring only parts integral with the port 118 and/or the earpiece 116 to make the connection.

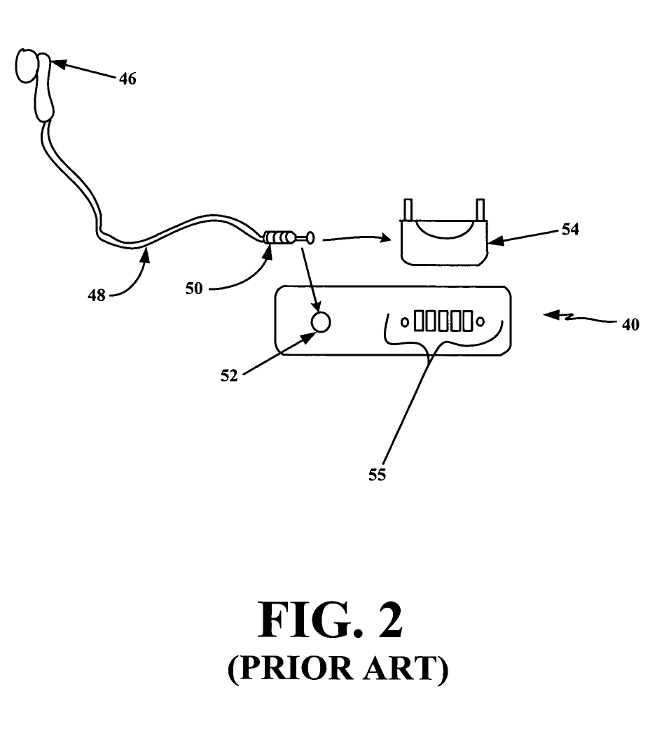

The terminal 114 of the base 112 is for connection to an audio device terminal. Audio devices, such as cellular phones, have terminals that allow the battery to be charged when the phone is connected in a charger, allow the user to insert the phone in a cradle for use in a hands-free car phone arrangement, or allow a combined speaker/microphone earpiece (such as the earpiece discussed with reference to FIG. 2) to be coupled to the phone. The terminal 114 may include a release mechanism 120 to allow the terminal of the audio device and the terminal 114 of the base 112 to be disconnected. The terminal 114 may have a pair of mechanical fasteners 122 for securing the terminal 114 to the audio device. The mechanical fasteners 122 may fit in openings of audio devices. The mechanical fasteners 122 can be designed to give the user the ability to repeatably couple and decouple the actuator assembly 110 to an audio device. Many different types of suitable mechanical fasteners can be used to couple these components together. Mechanical fasteners are well known to those having ordinary skill in the art.

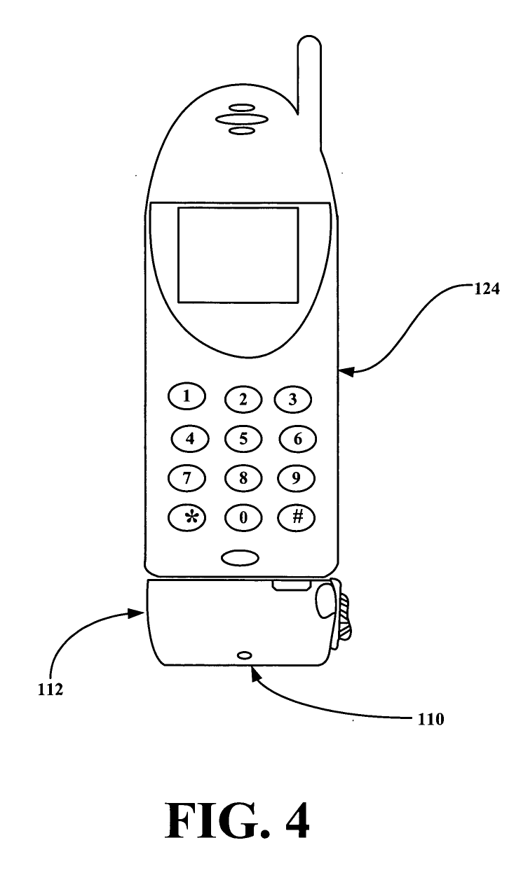

The audio devices may include one of an AM/FM radio, a CD player, an MP3 player, a cassette player, a personal digital assistant, a computer, a cordless phone, a radiophone, and a cellular phone. FIG. 4 is a front view of the actuator assembly 110 of FIG. 3 coupled to an audio device 124, a wireless phone, in accordance with the first exemplary embodiment of the invention. The actuator assembly 110 is shown extending generally downward from the base of the audio device 124. The actuator assembly 110 may attach to and extend from other sides of the audio device 124, dependent primarily upon the location of the audio device terminal. The actuator assembly 110 may also operate as a stand within which to mount the audio device 124.

In the embodiment shown in FIG. 4, the base 112 is capable of being coupled to the audio device 124 terminal. The mechanical fasteners 122 (shown in FIG. 3) of the base 112 fit into an opening of the audio device 124. In one design, the actuator assembly 110 may be integral with the audio device 124, i.e., not capable of being decoupled. The actuator assembly 110 may further optionally include a microphone in communication with the audio device 124 through the terminal (not shown in FIG. 4) of the base 112.

Returning to FIG. 3, a molded cradle 128 may be formed within the port 118 of the base 112 to hold the earpiece 116 and/or microphone, when not in use. The earpiece 116 can be secured in the molded cradle 128 with a locking mechanism 130. The earpiece 116 is coupled to the terminal 114 in one of a variety of ways, including, but not limited to a cable, infrared technology, and radio wave technology. The locking mechanism 130 may include a contoured grip portion 132. The locking mechanism 130 is shown protruding from the side of the base 112. Alternatively, the locking mechanism 130 can be designed not to protrude from the side of the base 112.

The actuator assembly 110 includes a sensor 134. The sensor 134 may be electrically coupled to the terminal 114 on the base 112. In the event, for example, the audio device 124 receives an incoming call, the user can simply set off the sensor 134 to pick up the incoming call. The sensor 134 may be arranged to sense if the earpiece 116 is withdrawn from the base 112. When the state of the earpiece 116 is changed by removal of the earpiece 116 from the cradle 128, the audio device 124 can be signaled through terminal 114 to pick up an incoming call.

The sensor 134 may be arranged to sense if the earpiece 116 is moved. The sensor 134 may be a Hall effect sensor or an optical sensor. Methods for sensing motion are well known to those having ordinary skill in the art. When motion or rotation is sensed, the audio device 124 may be signaled through terminal 114. In the event the audio device 124 receives an incoming call, the sensed movement or rotation can signal the audio device 124 to pick up the incoming call.

By having the actuator assembly 110 electrically coupleable to the audio device 124, the audio device 124 can be programmed to respond differently depending on the state of the earpiece 116.

In the first exemplary embodiment, the earpiece 116 is secured in the base 112 at the molded cradle 128, by the locking mechanism 130. To decouple the earpiece 116 from the base 112, the user can urge the locking mechanism 130 downward. Alternatively, the base 112 can be designed to allow the earpiece 116 to snap into the base 112 without the need for the locking mechanism 130.

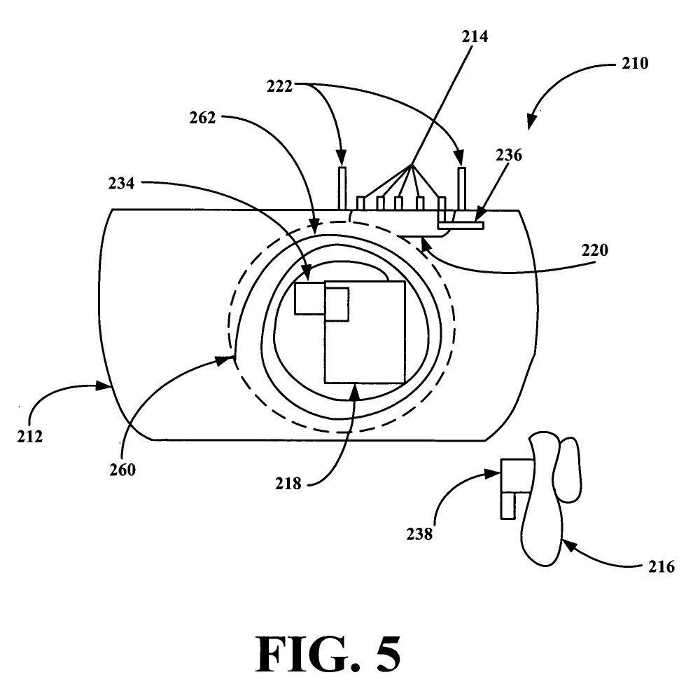

FIG. 5 is a front view of an actuator assembly 210, in accordance with a second exemplary embodiment of the invention. The actuator assembly 210 includes a base 212 and at least one terminal 214 integral with the base 212 whereby the terminal 214 connects to an audio device (not shown in FIG. 5). An earpiece 216 is in communication with the base 212, whereby the earpiece 216 receives audio signals from the base 212. A port 218 is formed within the base 212 and is capable of independent physical connection with the earpiece 216. Independent physical connection herein defined as requiring only parts integral with the port 218 and/or the earpiece 216 to make the connection.

The terminal 214 of the base 212 is for connection to an audio device terminal. Audio devices, such as cellular phones, have terminals that allow the battery to be charged when the phone is connected in a charger, allow the user to insert the phone in a cradle for use in a hands-free car phone arrangement, or allow a combined speaker/microphone earpiece to be coupled to the phone. The terminal 214 may include a release mechanism 220 to allow the terminal of the audio device and the terminal 214 of the base 212 to be disconnected. The terminal 214 may have a pair of mechanical fasteners 222 for securing the terminal 214 to the audio device. The mechanical fasteners 222 may fit in openings of audio devices. The mechanical fasteners 222 can be designed to give the user the ability to repeatably couple and decouple the actuator assembly 210 to an audio device. Many different types of suitable mechanical fasteners can be used to couple these components together. Mechanical fasteners are well known to those having ordinary skill in the art.

The actuator assembly 210 may include an antenna 236 electrically connected to the terminal 214, wherein the earpiece 216 is in communication with the base 212 through the antenna 236 using radio waves. While an antenna 236 is used in the second exemplary embodiment, other known wireless communications means are contemplated by the present invention. The actuator assembly 210 may include a tab 238 on the earpiece 216, wherein the tab 238 connects to the port 218. The port 218 may include a rotatable reel 260 that is rotatable up to about one hundred eighty degrees within the base 212. The tab 238 may work, in conjunction with the rotatable reel 260, to create a mechanical independent physical connection between the port 218 and the earpiece 216. For instance, the tab 238 may be inserted into the rotatable reel 260 and rotated to interlock the earpiece 216 with the port 218.

The actuator assembly 210 includes a sensor 234. The sensor 234 may be electrically coupled to the terminal 214 on the base 212. The sensor 234 may be located within the base 212 and proximate to the port 218. Rotating the tab 238 within the port 218 may then activate the sensor 234. Upon activation, the sensor 234 may actuate an audio device.

The tab 238 may have at least two positions to which it may be rotated within the base 212. The first position, a nonactivation position, is one in which the tab 238 is secured within the base 212 at the rotatable reel 260 of port 218. The second position, an activation position, is one in which the tab 238, and the earpiece 216 therethrough, is removable from the base 212. The tab 238 may be rotated between the two positions within the base 212 in conjunction with the rotatable reel 260. The sensor 234 may be arranged to activate when the tab 238 is removed from the base 212 or it may be arranged to activate when the rotatable reel 260 is rotated.

The rotatable reel 260 may further include a biasing member 262, located within the base 212, that biases the rotatable reel 260 in the nonactivation position. The biasing member 262 may be connected to the sensor 234, activating the sensor 234 when the rotatable reel 260 is rotated from the nonactivation position.

As shown in FIG. 5, the rotatable reel 260 is urged to rotate counterclockwise by the biasing member 262. In this second exemplary embodiment, the biasing member 262 constantly urges the rotatable reel 260 to rotate. The actuator assembly 210 can be designed to require that the earpiece 216 be rotated within the port 218, for example 90° clockwise, prior to removal from the base 212. Other angles of rotation for earpiece 216 removal are possible.

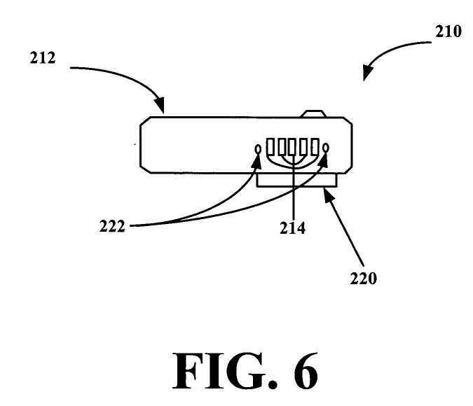

FIG. 6 is a side view of the actuator assembly 210, in accordance with the second exemplary embodiment of the invention. As shown, the earpiece 216 may sit at least partially exterior to the base 212, although mounting the earpiece 216 entirely within the base is within the scope of the invention. If the earpiece 216 is mounted within the base 212, a locking mechanism may be utilized to seal the opening of the port 218. As discussed herein, the earpiece 216 may be removed from the base 212 by rotating the earpiece 216 in relation to the base 212 to allow the tab 238 to release from the port 218.

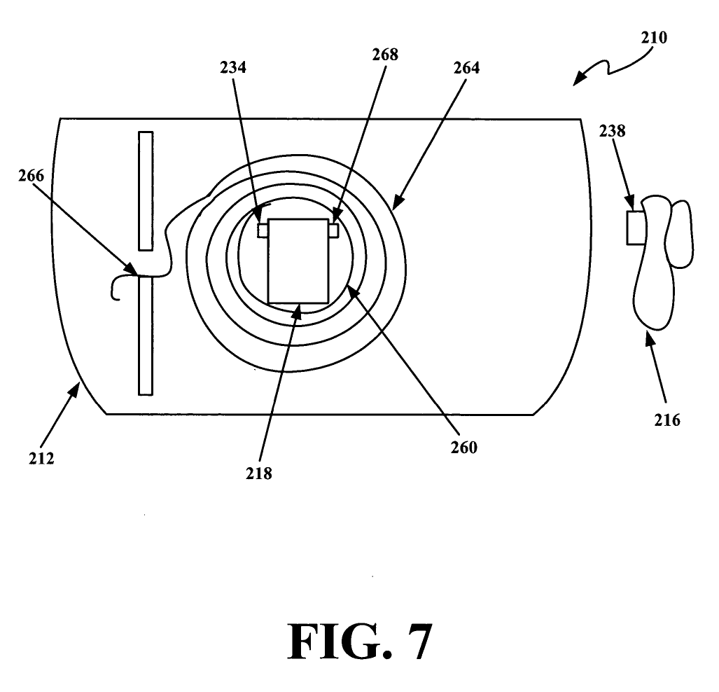

FIG. 7 is a cross-sectional view of a portion of the actuator assembly 210, in accordance with the second exemplary embodiment of the invention. The rotatable reel 260 is at an interior portion of a spiral spring connector 264. An exterior end 266 of the spiral spring connector 264 is held in a rigid position. As the tab 238 of the earpiece 216 is rotated within the port 218, the rotatable reel 260 is rotated. As the rotatable reel 260 rotates in a clockwise direction, the spiral spring connector 264 is tightened, increasing a counterclockwise force applied by the spiral spring connector 264. As the rotatable reel 260 rotates in a counter clockwise direction, the spiral spring connector 264 loosens, diminishing a counterclockwise force applied by the spiral spring connector 264. A lever 268 may engage the spiral spring connector 264 when the earpiece 216 is removed from the port 218, holding the spiral spring connector 264 in an activation position, which is also a position for receiving the earpiece 216. The lever 268, may, for instance, slide into the port 218 to engage the port 218 and the spiral spring connector 264, when the earpiece 216 is removed from the port 218. The lever 268 may be disengaged by the earpiece 216 when the earpiece 216 is inserted into the port 218, pushing the lever 268 out of the port 218, allowing the spiral spring connector 264 to turn the rotatable reel 260 into the nonactivation position.

The sensor 234, for example, may be a circuit that is opened when the rotatable reel 260 is nonactivation position and closed when the rotatable reel 260 is in the activation position. In this example, closing the circuit by rotating the rotatable reel 260 into the activation position may actuate the earpiece 216, allowing audio signals to be transmitted from the audio device, through the base 212, to the earpiece 216.

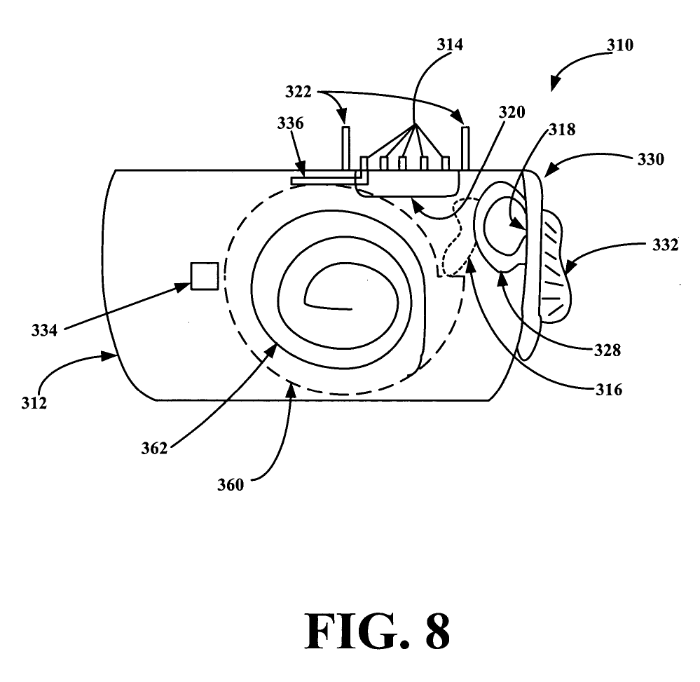

FIG. 8 is a front view of an actuator assembly 310, in accordance with a third exemplary embodiment of the invention. The actuator assembly 310 includes a base 312 and at least one terminal 314 integral with the base 312 whereby the terminal 314 connects to an audio device (not shown in FIG. 8). An earpiece 316 is in communication with the base 312, whereby the earpiece 316 receives audio signals from the base 312. A port 318 is formed within the base 312 and is capable of independent physical connection with the earpiece 316. Independent physical connection herein defined as requiring only parts integral with the port 318 and/or the earpiece 316 to make the connection.

The terminal 314 of the base 312 is for connection to an audio device terminal. Audio devices, such as cellular phones, have terminals that allow the battery to be charged when the phone is connected in a charger, allow the user to insert the phone in a cradle for use in a hands-free car phone arrangement, or allow a combined speaker/microphone earpiece to be coupled to the phone. The terminal 314 may include a release mechanism 320 to allow the terminal of the audio device and the terminal 314 of the base 312 to be disconnected. The terminal 314 may have a pair of mechanical fasteners 322 for securing the terminal 314 to the audio device. The mechanical fasteners 322 may fit in openings of audio devices. The mechanical fasteners 322 can be designed to give the user the ability to repeatably couple and decouple the actuator assembly 310 to an audio device. Many different types of suitable mechanical fasteners can be used to couple these components together. Mechanical fasteners are well known to those having ordinary skill in the art.

The actuator assembly 310 may include an antenna 336 electrically connected to the terminal 314, wherein the earpiece 316 is in communication with the base 312 through the antenna 336 using radio waves. The port 318 may be proximate to a rotatable reel 360 that is rotatable up to about one hundred eighty degrees within the base 312. The earpiece 316 may work, in conjunction with the rotatable reel 360, to affect communication between the base 312 and the earpiece 316, as is described herein.

A molded cradle 328 may be formed in the base 312 to hold the earpiece 316 within the port 318, when not in use. The earpiece 316 can be secured in the molded cradle 328 with a locking mechanism 330. The earpiece 316 is coupled to the terminal 314 in one of a variety of ways, including, but not limited to a cable, infrared technology, and radio wave technology. The locking mechanism 330 may include a contoured grip portion 332. The locking mechanism 330 is shown protruding from the side of the base 312. Alternatively, the locking mechanism 330 can be designed not to protrude from the side of the base 312.

The actuator assembly 310 includes a sensor 334. The sensor 334 may be electrically coupled to the terminal 314 on the base 312. The sensor 334 may be located within the base 312 and interactive with the rotatable reel 360. At least partially rotating the rotatable reel 360 may activate the sensor 334. Upon activation, the sensor 334 may actuate an audio device and allow the base 312 to transmit audio signals from the audio device to the earpiece 316.

The rotatable reel 360 may further include a biasing member 362, located within the base 312, that biases the rotatable reel 360 in the activation position. The biasing member 362 may be connected to the sensor 334, activating the sensor 334 when the rotatable reel 360 is rotated into the activation position.

As shown in FIG. 8, the rotatable reel 360 is urged to rotate counterclockwise by the biasing member 362. In this third exemplary embodiment, the biasing member 362 constantly urges the rotatable reel 360 to rotate into the activation position. The biasing member 362 can be designed to urge the rotatable reel 360 to be rotated, with respect to the base 312, for example, fifteen degrees clockwise, when the earpiece 316 is removed from the base 312. Returning the earpiece 316 to the base 312 may then rotate the rotatable reel 360 to the nonactivation position. Other angles of rotation for the rotatable reel 360 are contemplated.

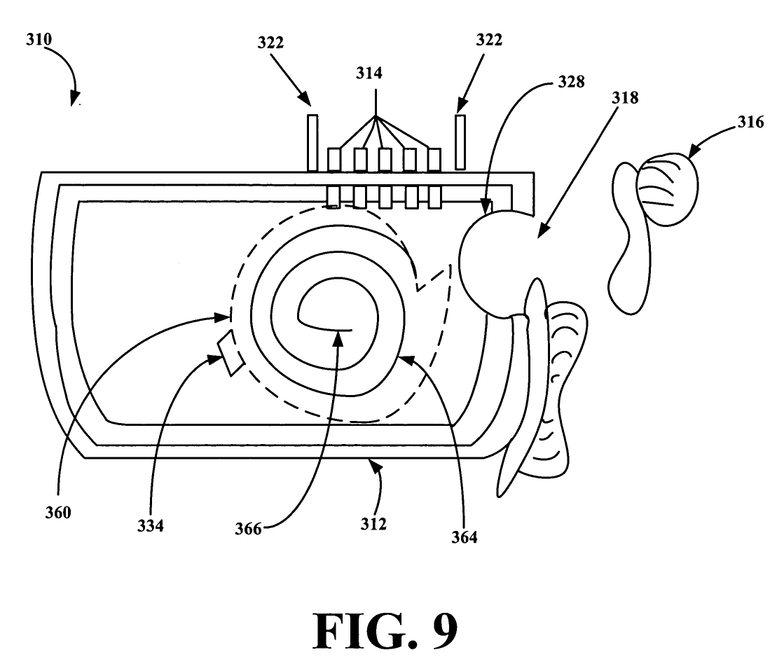

FIG. 9 is a cross-sectional view of a portion of the actuator assembly 310, in accordance with the third exemplary embodiment of the invention. The rotatable reel 360 is at an exterior portion of a spiral spring connector 364. An interior end 366 of the spiral spring connector 364 is held in a rigid position. Insertion of or removal of the earpiece 316 may cause the rotatable reel 360 to rotate. As the rotatable reel 360 rotates in a clockwise direction, the spiral spring connector 364 is tightened, increasing a counterclockwise force applied by the spiral spring connector 364. As the rotatable reel 360 rotates in a counter clockwise direction, the spiral spring connector 364 loosens, diminishing a counterclockwise force applied by the spiral spring connector 364.

The sensor 334, for example, may be a circuit that is opened when the rotatable reel 360 is in the nonactivation position and closed when the rotatable reel 360 is in the activation position. Removing the earpiece 316 from the base 312 allows the spiral spring connector 364 to urge the rotatable reel 360 into the activation position, closing the circuit of the sensor 334. In this example, closing the circuit by rotating the rotatable reel 360 into the activation position may actuate the earpiece 316, allowing audio signals to be transmitted from the audio device, through the base 312, to the earpiece 316.

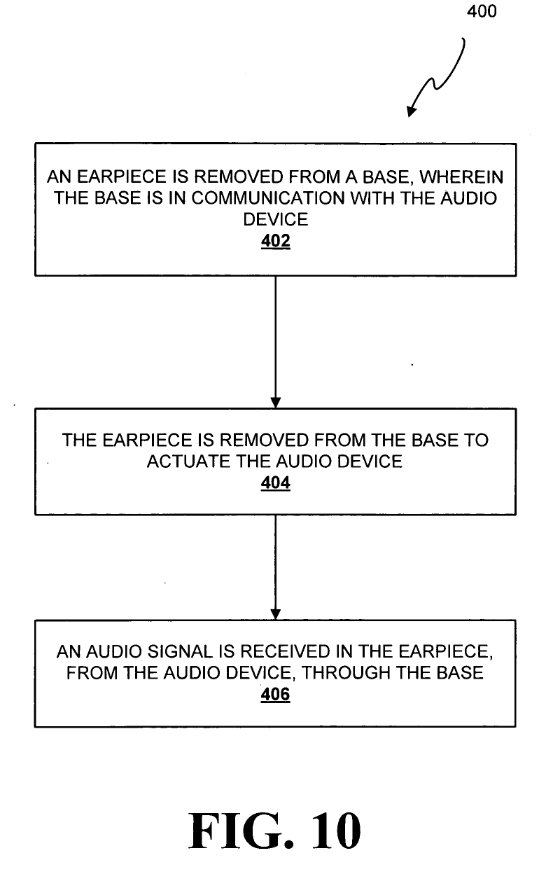

The flow chart of FIG. 10 shows the functionality and operation of a possible implementation of the actuator assembly 110 to listen to an audio device 124, in accordance with the first exemplary embodiment of the invention. In this regard, each block represents a module, segment, or step, which comprises one or more instructions for implementing the specified function. It should also be noted that in some alternative implementations, the functions noted in the blocks might occur out of the order noted in FIG. 10. For example, two blocks shown in succession in FIG. 10 may in fact be executed substantially, concurrently or the blocks may sometimes be executed in the reverse order, depending upon the functionality involved, as will be further clarified herein.

As shown in FIG. 10, a method 400 for listening to an audio device 124 includes removing an earpiece 116 from a base 112, wherein the base 112 is in communication with the audio device 124 (block 402). The earpiece 116 is removed from the base 112 to actuate the audio device 124 (block 404). An audio signal is received in the earpiece 116, from the audio device 124, through the base 112 (block 406). Communication from the base 112 to the earpiece 116 may use radio signals, although other methods of wireless communication known to those having ordinary skill in the art are contemplated by the present invention and are considered to be within the scope of the claims.

It should be emphasized that the above-described embodiments of the present invention are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

1. An actuator assembly for use with an audio device, the actuator comprising:
a base;
at least one terminal integral with the base whereby the terminal connects to the audio device;
an earpiece in communication with the base, whereby the earpiece receives audio signals from the base; and
a port formed within the base capable of independent physical connection with the earpiece.

2. The actuator assembly of claim 1, further comprising an antenna electrically connected to the terminal, wherein the earpiece is in communication with the base through the antenna using radio waves.

3. The actuator assembly of claim 1, wherein the audio device is a wireless phone.

4. The actuator assembly of claim 3, wherein the wireless phone is a cellular phone.

5. The actuator assembly of claim 1, further comprising a tab on the earpiece, wherein the tab connects to the port.

6. The actuator assembly of claim 5, wherein the port further comprises a rotatable reel that is rotatable up to about one hundred eighty degrees within the base.

7. The actuator assembly of claim 5, wherein the tab is rotatable up to one hundred eighty degrees within the port.

8. The actuator assembly of claim 7, further comprising a sensor within the base and proximate to the port, the sensor electronically connected to the terminal, whereby rotating the tab within the port activates the sensor and initiates the audio device.

9. The actuator assembly of claim 8, wherein the tab has an activation position within the base and a nonactivation position within the base, wherein the tab is locked within the base in the nonactivation position and is removable from the base in the activation position.

10. The actuator assembly of claim 9, further comprising a biasing member within the port that biases the tab in a nonactivation position, the biasing member connected to the sensor, whereby rotating the tab against the biasing member actuates the sensor.

11. The actuator assembly of claim 5, further comprising a sensor within the base and proximate to the port, the sensor electronically connected to the terminal, whereby removal of the earpiece and tab from the port activates the sensor and initiates the audio device.

12. The actuator assembly of claim 8, wherein the sensor is selected from the group consisting of a Hall effect sensor and an optical sensor.

13. The actuator assembly of claim 1, further comprising a microphone coupled to the earpiece.

14. A method for listening to an audio device, the method comprising the steps of:
removing an earpiece from a base, wherein the base is in communication with the audio device;
actuating the audio device by removing the earpiece from the base; and
receiving an audio signal in the earpiece, from the audio device, through the base.

15. The method of claim 14, wherein the step of removing the earpiece further comprises removing a tab integral with the earpiece from a port integral with the base.

16. The method of claim 15, wherein the step of removing the earpiece further comprises rotating the tab within the port before removing the earpiece.

17. The method of claim 16, wherein the step of actuating the audio device further comprises actuating a sensor in communication with the audio device by rotating the tab within the port.

18. The method of claim 16, further comprising the step of biasing the tab to a nonactivation rotational position within the port.

19. The method of claim 14, further comprising the step of deactivating the audio device by returning the earpiece to the base.

20. A system for listening to an audio device, the system comprising:
means for removing an earpiece from a base, wherein the base is in communication with the audio device;
means for actuating the audio device by removing the earpiece from the base, wherein the means for actuating further comprises means for rotating the earpiece within the base; and
means for receiving an audio signal in the earpiece, from the audio device, through the base.
